(19) United States
(12) Patent Application Publication
(10) Pub. No.: US 2025/0365660 A1
(43) Pub. Date: Nov. 27, 2025

(54) ELECTRONIC DEVICE FOR PROVIDING USER INTERFACE ASSOCIATED WITH POWER-SAVING FUNCTION AND OPERATION METHOD THEREOF

(71) Applicant: Samsung Electronics Co., Ltd., Suwon-si (KR)

(72) Inventors: Jiwon JEON, Suwon-si (KR); Youngchan WOO, Suwon-si (KR); Jiwoo HONG, Suwon-si (KR)

(21) Appl. No.: 19/293,545

(22) Filed: Aug. 7, 2025

Related U.S. Application Data
(63) Continuation of application No. PCT/KR2024/001205, filed on Jan. 25, 2024.

(30) Foreign Application Priority Data
Mar. 14, 2023 (KR) 10-2023-0033161

(51) Int. Cl. H04W 52/02; G06F 3/0482; G06F 3/0484; G09G 5/10

(52) U.S. Cl. CPC H04W 52/0206; G06F 3/0482; G06F 3/0484; G09G 5/10; G06F 2203/04803; G09G 2320/0626; G09G 2320/0686; G09G 2330/023; G09G 2354/00

(57) ABSTRACT

A method performed by an electronic device is disclosed. The method includes obtaining, by the electronic device, information regarding a power usage state of the electronic device, determining, by the electronic device, based on the information regarding the power usage state, whether the electronic device satisfies at least one condition for executing a power saving mode, identifying, by the electronic device, a first time indicating an estimated available time of the electronic device in response to determining that the electronic device satisfies the at least one condition for executing the power saving mode, identifying, by the electronic device, a second time indicating a time required for a user of the electronic device to perform a task, determining, by the electronic device, whether the second time is greater than the first time, performing, by the electronic device, at least one power saving function for reducing power consumption in response to determining that the second time is greater than the first time, and displaying, by the electronic device, a user interface regarding a power saving function providable by the electronic device, wherein the user interface includes one or more second objects for executing one or more power saving options providable by the electronic device.

### CROSS-REFERENCE TO RELATED APPLICATION(S)

This application is a continuation application, claiming priority under 35 U.S.C. § 365 (c), of an International application No. PCT/KR2024/001205, filed on Jan. 25, 2024, which is based on and claims the benefit of a Korean patent application number 10-2023-0033161, filed on Mar. 14, 2023, in the Korean Intellectual Property Office, the disclosure of which is incorporated by reference herein in its entirety.

### BACKGROUND

### 1. Field

The disclosure relates to an electronic device for providing a user interface regarding a power saving function and an operation method thereof.

### 2. Description of Related Art

Electronic devices (e.g., smartphones, tablet personal computers (PCs), desktops, televisions (TVs), etc.) may provide a power saving function to reduce power consumption and extend battery life. For example, the electronic device may provide a power saving function by deactivating a function of some hardware or a function of software. For example, the electronic device may reduce the brightness of the screen, thereby reducing the overall power consumption of the screen.

In relation to the power saving function provided by the electronic device, the electronic device may measure the estimated usage time of the battery. The electronic device may predict the amount of power that may be provided by the battery included in the electronic device by measuring the voltage and the current of the battery. However, the estimated usage time of the electronic device may vary according to the type of the electronic device, the operating system, the activated function, or the like.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method of operating the electronic device to provide a power saving function based on the type of a running application in the electronic device.

Another aspect of the disclosure is to provide an electronic device and a method of operating the electronic device to provide a user interface that may prompt the user's selection in relation to the power saving function.

Another aspect of the disclosure is to provide an electronic device and a method of operating the electronic device to provide a user interface that visually displays the effects that are exhibited when executing a power saving function.

Additional aspects will be set forth in part in the description which follows and, in part, will be apparent from the description, or may be learned by practice of the presented embodiments.

In accordance with an aspect of the disclosure, a method performed by an electronic device is provided. The method includes obtaining, by the electronic device, information regarding a power usage state of the electronic device, determining, by the electronic device, based on the information regarding the power usage state, whether the electronic device satisfies at least one condition for executing a power saving mode, identifying, by the electronic device, a first time indicating an estimated available time of the electronic device in response to determining that the electronic device satisfies the at least one condition for executing the power saving mode, identifying, by the electronic device, a second time indicating a time required for a user of the electronic device to perform a task, determining, by the electronic device, whether the second time is greater than the first time, performing, by the electronic device, at least one power saving function for reducing power consumption in response to determining that the second time is greater than the first time, and displaying, by the electronic device, a user interface regarding a power saving function providable by the electronic device, wherein the user interface includes one or more second objects for executing one or more power saving options providable by the electronic device.

In accordance with another aspect of the disclosure, the method of the electronic device is provided. The method of electronic device includes displaying a first object indicating an object for identifying a user input regarding whether to perform the at least one power saving function for reducing power consumption in response to determining that the second time is greater than the first time, and performing the at least one power saving function in response to identifying a user input through the first object.

In an embodiment, the user interface includes an object indicating information regarding an estimated available time of the electronic device changed as the at least one power saving function is performed.

The method of the electronic device according to an embodiment includes identifying a user input for selecting at least one of the one or more second objects, and performing a power saving function corresponding to the at least one second object in response to identifying the user input for selecting the at least one second object.

In an embodiment, the user interface includes an object indicating information regarding an estimated usage time of the electronic device changed as the power saving function corresponding to the at least one second object is performed.

In an embodiment, at least one condition for the electronic device to execute the power saving mode includes at least one of a first condition indicating that the electronic device identifies that a battery status of the electronic device is less than a first threshold, a second condition indicating that the electronic device identifies that a power consumption rate of the electronic device is a second threshold or more, or a third condition including a case where it is identified that the electronic device executes at least one predetermined application among a plurality of applications installed on the electronic device.

The method of the electronic device according to an embodiment includes displaying a first screen indicating an execution screen of a first application and a second screen indicating an execution screen of a second application, identifying a user input for expanding the first screen and reducing the second screen, and increasing a brightness of the first screen and decreasing a brightness of the second screen in response to identifying the user input for expanding the first screen and reducing the second screen.

The method of the electronic device according to an embodiment includes increasing a system resource allocated to the first application and reducing a system resource allocated to the second application in response to identifying the user input for expanding the first screen and reducing the second screen.

In an embodiment, the at least one power saving function includes a function of reducing a size of a screen output area and a function of reducing a screen brightness.

The method of the electronic device according to an embodiment includes displaying the screen output area reduced as the function of reducing the size of the screen output area is performed, identifying a user input for adjusting the reduced size of the screen output area, identifying an estimated available time of the electronic device changed, in response to the user input for adjusting the reduced size of the screen output area, and displaying information regarding the changed estimated available time of the electronic device.

In accordance with another aspect of the disclosure, an electronic device is provided. The electronic device includes a display, memory, comprising one or more storage media, storing instructions, and at least one processor, communicatively coupled to the display and the memory, including a processing circuit, wherein the instructions, when executed by the at least one processor individually or collectively, cause the electronic device to obtain information regarding a power usage state of the electronic device, determine, based on the information regarding the power usage state, whether the electronic device satisfies at least one condition for executing a power saving mode, identify a first time indicating an estimated available time of the electronic device in response to determining that the electronic device satisfies the at least one condition for executing the power saving mode, identify a second time indicating a time required for a user of the electronic device to perform a task, determine whether the second time is greater than the first time, perform at least one power saving function for reducing power consumption in response to determining that the second time is greater than the first time, and display a user interface regarding a power saving function providable by the electronic device, and wherein the user interface includes one or more second objects for executing one or more power saving options providable by the electronic device.

The instructions, when executed by the at least one processor individually or collectively, further cause the electronic device to display a first object indicating an object for identifying a user input regarding whether to perform the at least one power saving function for reducing power consumption in response to determining that the second time is greater than the first time, and perform the at least one power saving function in response to identifying a user input through the first object.

In an embodiment, the instructions, when executed by the at least one processor individually or collectively, further cause the electronic device to identify a user input for selecting at least one of the one or more second objects, and perform a power saving function corresponding to the at least one second object in response to identifying the user input for selecting the at least one second object.

In an embodiment, the at least one processor identifies a user input for selecting at least one of the one or more second objects. The at least one processor according to an embodiment performs a power saving function corresponding to the at least one second object in response to identifying the user input for selecting the at least one second object.

In an embodiment, the user interface includes an object indicating information regarding an estimated usage time of the electronic device changed as the power saving function corresponding to the at least one second object is performed.

In an embodiment, at least one condition for the electronic device to execute the power saving mode includes at least one of a first condition indicating that the electronic device identifies that a battery status of the electronic device is less than a first threshold, a second condition indicating that the electronic device identifies that a power consumption rate of the electronic device is a second threshold or more, or a third condition including a case where it is identified that the electronic device executes at least one predetermined application among a plurality of applications installed on the electronic device.

The instructions, when executed by the at least one processor individually or collectively, further cause the electronic device to display a first screen indicating an execution screen of a first application and a second screen indicating an execution screen of a second application, identify a user input for expanding the first screen and reducing the second screen, and increase a brightness of the first screen in response to identifying the user input for expanding the first screen and reducing the second screen.

The instructions, when executed by the at least one processor individually or collectively, further cause the electronic device to reduce a system resource allocated to the first application in response to identifying the user input for expanding the first screen and reducing the second screen.

In an embodiment, the at least one power saving function includes a function of reducing a size of a screen output area and a function of reducing a screen brightness.

The instructions, when executed by the at least one processor individually or collectively, further cause the electronic device to display the screen output area reduced as the function of reducing the size of the screen output area is performed. The at least one processor according to an embodiment identify a user input for adjusting the reduced size of the screen output area. The at least one processor according to an embodiment identify an estimated available time of the electronic device changed, in response to the user input for adjusting the reduced size of the screen output area. The at least one processor according to an embodiment display information regarding the changed estimated available time of the electronic device.

In accordance with another aspect of the disclosure, one or more non-transitory computer-readable storage media storing one or more computer programs including computer-executable instructions that, when executed by at least one processor of an electronic device individually or collectively, cause the electronic device to perform operations, are provided. The operations include obtaining, by the electronic device, information regarding a power usage state of the electronic device, determining, by the electronic device, based on the information regarding the power usage state, whether the electronic device satisfies at least one condition for executing a power saving mode, identifying, by the electronic device, a first time indicating an estimated available time of the electronic device in response to determining that the electronic device satisfies the at least one condition for executing the power saving mode, identifying, by the electronic device, a second time indicating a time required for a user of the electronic device to perform a task, determining, by the electronic device, whether the second time is greater than the first time, performing, by the electronic device, at least one power saving function for reducing power consumption in response to determining that the second time is greater than the first time, and displaying, by the electronic device, a user interface regarding a power saving function providable by the electronic device, wherein the user interface includes one or more second objects for executing one or more power saving options providable by the electronic device.

According to the examples disclosed in the disclosure, the user selects a function that may be used for power saving of an electronic device, thereby providing an effect of enhancing the user experience.

The disclosure provides the effect of providing an appropriate power saving function according to the user's electronic device usage environment and the state of the electronic device.

It is also possible to complete a task performed by a user through an electronic device by providing a power saving function based on an application being currently executed, as well as the remaining battery level.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a configuration of an electronic device according to an embodiment of the disclosure;

FIG. 2 illustrates a block diagram for providing a power saving function of an electronic device according to an embodiment of the disclosure;

FIG. 3 illustrates an operation flow of an electronic device according to an embodiment of the disclosure;

FIG. 4 illustrates an operation flow for identifying a first time of an electronic device according to an embodiment of the disclosure;

FIG. 5 illustrates an operation flow for identifying a second time of an electronic device according to an embodiment of the disclosure;

FIG. 6 illustrates an example of displaying a user interface of an electronic device according to an embodiment of the disclosure;

FIG. 7 illustrates an example of displaying a user interface of an electronic device according to an embodiment of the disclosure;

FIG. 8 illustrates an example of displaying a user interface of an electronic device according to an embodiment of the disclosure;

FIG. 9 illustrates an example of displaying a user interface of an electronic device according to an embodiment of the disclosure;

FIG. 10 illustrates an example of displaying a user interface of an electronic device according to an embodiment of the disclosure;

FIG. 11 illustrates an example of screen display of an electronic device according to an embodiment of the disclosure;

FIG. 12 illustrates an example of displaying a user interface of an electronic device according to an embodiment of the disclosure;

FIG. 13 illustrates an example of execution of a power saving function according to a user input of an electronic device according to an embodiment of the disclosure; and

FIG. 14 illustrates an example of execution of a power saving function according to a user input of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

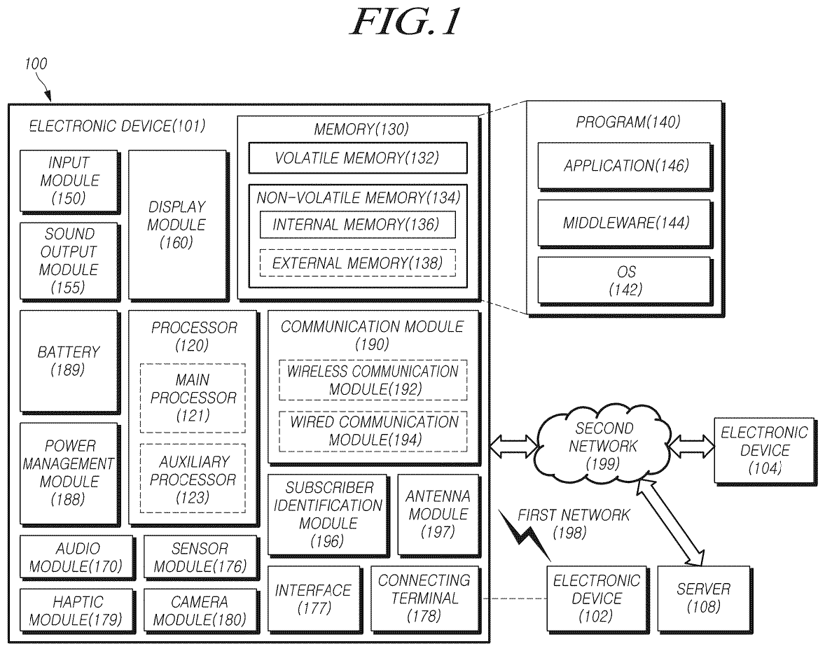

FIG. 1 is a block diagram illustrating an electronic device 101 in a network environment 100 according to an embodiment of the disclosure.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the sub processor 123, the sub processor 123 may be configured to use lower power than the main processor 121 or to be specified for a designated function. The sub processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™ wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197. According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

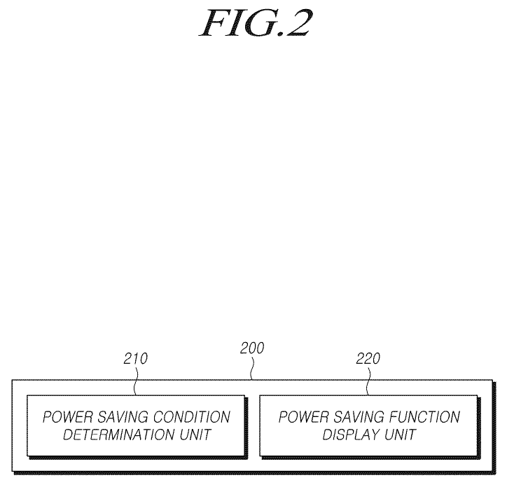

FIG. 2 is a block diagram illustrating an electronic device according to an embodiment of the disclosure.

The electronic device 200 illustrated in FIG. 2 may include an electronic device 101, be included in the network environment 100, or be the electronic device 101. In the description of FIG. 2, content overlapping the portion described with reference to FIG. 1 may be omitted.

The electronic device 200 according to an embodiment may include a power saving condition determination unit 210 and a power saving function display unit 220. The power saving condition determination unit 210 may determine whether the electronic device performs a power saving function. The power saving function display unit 220 may display a screen to which a power saving function is applied, a user interface including an object for identifying a user input for executing the power saving function, information regarding the remaining battery level changed as the power saving function is performed, or the like.

In an embodiment, the power saving condition determination unit 210 may monitor a power usage state of the electronic device to determine whether the electronic device meets at least one condition (hereinafter, referred to as a “first condition”) for executing the power saving function.

In an embodiment, the power saving condition determination unit 210 may periodically obtain the power usage information of the electronic device (e.g., information regarding the remaining battery level, information regarding the type of application running on the electronic device, and/or information regarding the power consumption rate of the electronic device).

In an embodiment, the power saving condition determination unit 210 may determine whether the electronic device meets at least one first condition based on the power usage information of the electronic device. For example, the first condition may include a case in which the remaining battery level of the electronic device is identified as less than or equal to a predetermined value (e.g., 30 percent). For example, the first condition may include a case in which the power consumption rate of the electronic device is identified as being more than or equal to a predetermined value. For example, the first condition may include a case in which the type of the application running on the electronic device is identified as any one of a plurality of predetermined applications.

In an embodiment, the power saving condition determination unit 210 may identify the estimated available time of the electronic device. The estimated available time of the electronic device may include a time for the electronic device to function when the current state (e.g., currently running application, current display setting (brightness, scan rate, activated display area, etc.) is maintained. In the following description, the estimated available time of the electronic device may be referred to as a “first time”.

In an embodiment, the power saving condition determination unit 210 may identify a time required for the electronic device to complete the user's task. The time required to complete the user's task may be identified based on information regarding the application currently running on the electronic device and/or information regarding the usage history of the electronic device. In the following description, the time required for the user to perform the task may be referred to as “second time”.

In an embodiment, the power saving condition determination unit 210 may compare the estimated available time (first time) of the electronic device with the time (second time) required for the user to perform the task, and determine whether the estimated available time of the electronic device is larger than the time required for the user's task to be completed.

In an embodiment, when the power saving condition determination unit 210 determines that the electronic device meets at least one first condition, the power saving function display unit 220 may display an object (hereinafter, referred to as a “first object”) for identifying a user input regarding whether to perform the power saving function. When the electronic device identifies the user input through the first object, the electronic device 200 may perform a power saving function.

In an embodiment, when the power saving condition determination unit 210 determines that the electronic device 200 meets a specific condition, the power saving function display unit 220 may perform at least one predetermined power saving function even if the user input is not identified through the first object. The specific condition may include one predetermined condition among at least one condition for performing the power saving function.

In an embodiment, the power saving function display unit 220 may display a user interface (UI) including an object (hereinafter, referred to as a “second object”) indicating at least one option that may be executed for power saving when identifying the user input through the first object or determining that the specific condition is met. When the user input is identified through the second object, the power saving function corresponding to the second object may be executed. The user interface may include an object representing information regarding the time when the electronic device may operate as the power saving function is performed. The user interface may include an object representing information regarding the power consumed by the electronic device as the power saving function is performed.

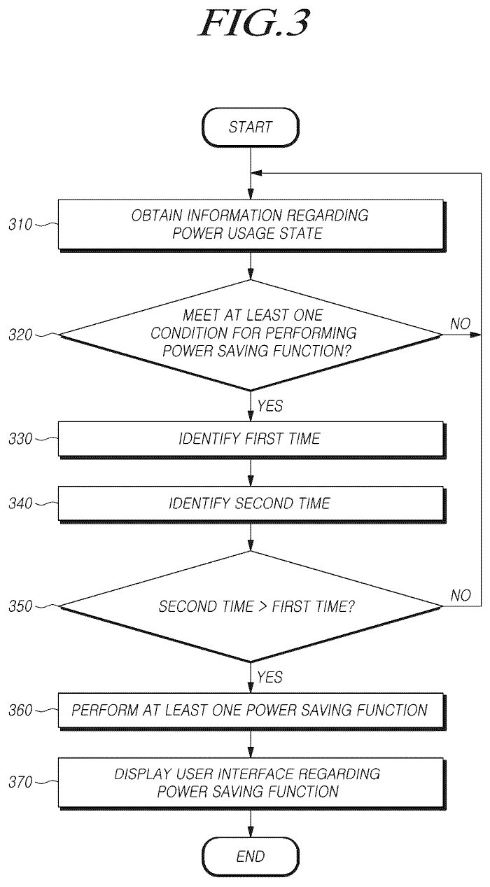

FIG. 3 illustrates an operation flow of an electronic device according to an embodiment of the disclosure.

The electronic device of FIG. 3 may include a device corresponding to the electronic device 101 of FIG. 1 and the electronic device 200 of FIG. 2. In the description of FIG. 3, the description of the portions overlapping the portions described with reference to FIGS. 1 and 2 may be omitted.

According to an embodiment, in operation 310, the electronic device may obtain information regarding the power usage state.

In an embodiment, the electronic device may monitor the power usage state of the electronic device and periodically obtain information regarding the power usage state of the electronic device. For example, the information regarding the power usage state of the electronic device may include information regarding the battery status of the electronic device, information regarding the application running on the electronic device, information regarding the electronic device's display settings (e.g., screen brightness, output scan rate, screen transparency, etc.), and/or information regarding the electronic device's power consumption rate.

According to an embodiment, in operation 320, the electronic device may determine whether the electronic device meets at least one condition (hereinafter, referred to as a “first condition”) for performing the power saving function based on the information regarding the power usage state.

In an embodiment, the at least one condition (hereinafter, referred to as the “first condition”) for the electronic device to perform the power saving function may include a triggering condition for the electronic device to identify the first time and the second time of FIG. 2. The at least one condition may be previously stored in the memory of the electronic device, and may be modified, added, or deleted according to the user's input. For example, at least one first condition may include a case in which the electronic device identifies that the remaining battery level of the electronic device is less than or equal to a predetermined level (e.g., 30 percent). For example, the at least one first condition may include a case in which the electronic device identifies that the power consumption rate of the electronic device is more than or equal to a predetermined value. For example, the at least one first condition may include a case in which the electronic device identifies that a specific application classified as consuming a lot of power is running. The electronic device may determine an application that consumes a predetermined value or more of power based on information regarding system resources, memory usage, CPU usage, etc. used when the application is executed, as an application that consumes a lot of power.

According to an embodiment, in operation 330, the electronic device may identify the first time indicating the estimated available time of the electronic device. The first time may represent a battery usage time that may be continued when the electronic device maintains a state (e.g., display settings (brightness, output scan rate), running application, etc.) at a time that meets the at least one first condition.

According to an embodiment, in operation 340, the electronic device may identify a second time indicating a time required for the user to perform the task.

In an embodiment, the electronic device may identify the second time based on information regarding the usage history of the electronic device. The information regarding the usage history may include information regarding a screen time of the electronic device, application usage information, and/or information regarding content being displayed. For example, based on the information about the screen time, the electronic device may identify the time when the user of the electronic device is predicted to primarily sleep (identified through methods like averaging), and based thereon, determine the remaining time from the current time (when the electronic device meets the first condition) to the time when the user is predicted to sleep as the second time. For example, if the application currently running on the electronic device is a map or navigation app, the predicted time to reach the destination may be determined as the second time. For example, if the application running on the electronic device is an application related to music or video, the time until the playback of the currently played music or video is completed may be determined as the second time.

According to an embodiment, in operation 350, the electronic device may determine whether the second time is larger than the first time. In other words, the electronic device may determine whether the available time of the electronic device is equal to or more than a time required for the user of the electronic device to perform the task.

In an embodiment, when the electronic device determines that the second time is not larger than the first time, the electronic device may return to operation 310 to monitor the power state of the electronic device.

According to an embodiment, when the electronic device determines that the second time is larger than the first time, the electronic device may perform operation 360.

In an embodiment, when the second time is determined to be larger than the first time, the electronic device may display an object (first object) for identifying a user input regarding whether to perform the power saving function. The first object may have a form of a pop-up window.

According to an embodiment, in operation 360, the electronic device may perform at least one power saving function. At least one power saving function may include a function to control an activated display area (e.g., size, transparency, etc.), a function to control the performance of a running application (e.g., output scan rate, CPU speed, etc.), and/or a network control function (e.g., airplane mode execution, disabling of Bluetooth, Wi-Fi, tethering, etc.).

In an embodiment, when identifying a user input through the first object, the electronic device may perform at least one predetermined power saving function.

In an embodiment, when there is no at least one predetermined power saving function, the electronic device may perform operation 370.

For example, the electronic device may reduce the brightness of the display of the electronic device to a predetermined value or less. For example, the electronic device may reduce the scan rate of the display. For example, the electronic device may deactivate an activated short-range communication function (e.g., Wi-Fi, Bluetooth, near field communication (NFC), etc.). For example, the electronic device may reduce the size of the activated display area (screen output area). For example, the electronic device may terminate an unused application (such as a background application). For example, the electronic device may reduce random access memory (RAM) usage. For example, the electronic device may reduce the number of colors displayed on the screen or switch to the black and white mode.

In an embodiment, the electronic device may reduce the size of the screen output area. The screen output area may be referred to as an “active area”. The electronic device may reduce the size of the active area of the display, thereby reducing power consumed in the inactive area. For example, the electronic device may adjust the resolution to be lower. For example, the electronic device may reduce the size of the screen output area by adjusting the ratio of the screen. For example, the electronic device may reduce the size of the screen output area by rotating the direction of the screen.

According to an embodiment, in operation 370, the user interface regarding the power saving function that may be performed by the electronic device may be displayed.

In an embodiment, the user interface may include at least one object (e.g., a toggle, a switch icon, a button, a check box, and a radio button) for executing at least one power saving function. In the following description, an object for executing at least one power saving function may be referred to as a “second object”.

In an embodiment, the user interface may include a second object representing information regarding an estimated available time expected when performing the power saving function.

In an embodiment, the user interface may include a second object representing information regarding estimated power consumption expected when performing the power saving function.

In an embodiment, when identifying a user input through the second object, the electronic device may perform the power saving function corresponding to the second object.

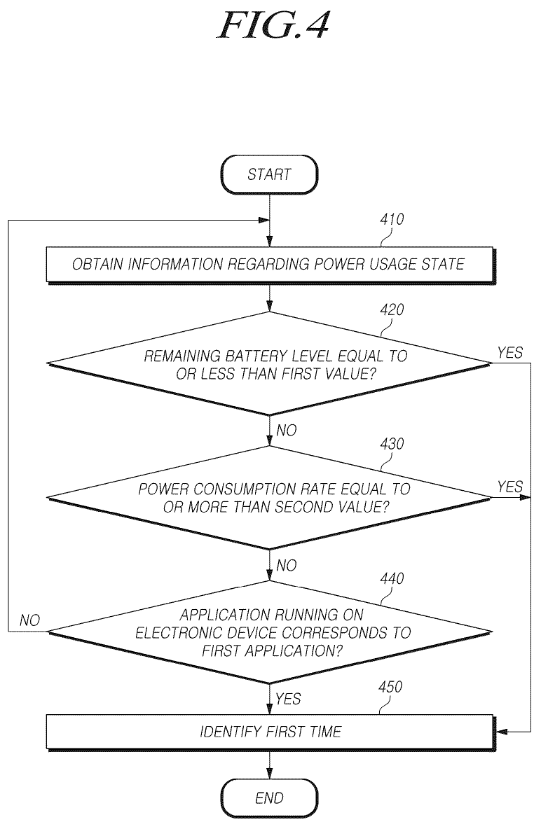

In an embodiment, when identifying a user input through the second object, the electronic device may display information regarding the estimated available time and/or the estimated power consumption that changes as the power saving function corresponding to the second object is performed. Portions not described in detail in the description of FIG. 3 may be described in detail in the description of FIGS. 4 to 14.

FIG. 4 illustrates an operation flow for identifying a first time of an electronic device according to an embodiment of the disclosure.

The electronic device of FIG. 4 may include a device corresponding to the electronic device 101 of FIG. 1, the electronic device 200 of FIG. 2, and the electronic device in the description of FIG. 3. The operation flow of FIG. 4 may include operations 310, 320, and 330 of FIG. 3. In the description of FIG. 4, the description of the portion overlapping the portion described with reference to FIGS. 1 to 3 may be omitted.

According to an embodiment, in operation 410, the electronic device may obtain information regarding the power usage state of the electronic device. Operation 410 may include operation contents according to operation 310 of FIG. 3.

According to an embodiment, in operation 420, the electronic device may determine whether the remaining battery level of the electronic device is less than or equal to a predetermined value based on the information regarding the power usage state of the electronic device.

In an embodiment, when the remaining battery level of the electronic device is less than or equal to the predetermined value, the electronic device may perform operation 450.

In an embodiment, when the remaining battery level of the electronic device is not less than or equal to the predetermined value, the electronic device may perform operation 430.

According to an embodiment, in operation 430, the electronic device may determine whether the power consumption rate of the electronic device is equal to or more than the predetermined value.

In an embodiment, when the power consumption rate of the electronic device is more than or equal to the predetermined value, the electronic device may perform operation 450.

In an embodiment, when the power consumption rate of the electronic device is not more than or equal to the predetermined value, the electronic device may perform operation 440.

According to an embodiment, in operation 440, the electronic device may determine whether the currently running application is a predetermined type of application (“first application”). For example, the predetermined type of application may include an application related to a video, a map, or a game.

In an embodiment, when determining that the currently running application is the predetermined type of application, the electronic device may perform operation 450.

In an embodiment, when determining that the currently running application is not the predetermined type of application, the electronic device may perform operation 410.

Although not illustrated in the drawings, the electronic device may change the order of operation 420, operation 430, and operation 440 according to the user's setting, or may omit some of operation 402, operation 430, or operation 440.

According to an embodiment, in operation 450, the electronic device may calculate the estimated available time (first time) of the electronic device. Operation 450 may include all operations corresponding to operation 330 of FIG. 3.

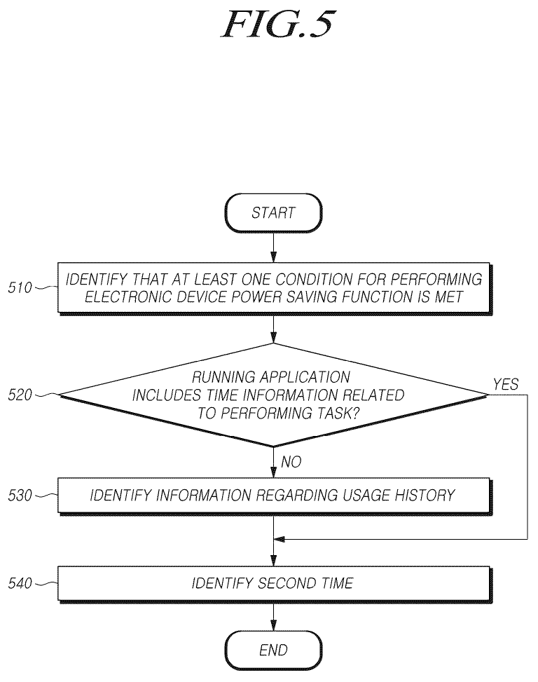

FIG. 5 illustrates an operation flow for identifying a second time of an electronic device according to an embodiment of the disclosure.

The electronic device of FIG. 5 may include a device corresponding to the electronic device 101 of FIG. 1, the electronic device 200 of FIG. 2, and the electronic device of FIGS. 3 and 4. In the description of FIG. 5, the description of the portions overlapping the portions described with reference to FIGS. 1 to 4 may be omitted. FIG. 5 may include operation contents according to operation 340 of FIG. 3. In other words, the operation according to FIG. 5 may include an operation performed after the electronic device meets at least one condition for executing the power saving function.

According to an embodiment, in operation 510, the electronic device may identify that the electronic device meets at least one condition for performing the power saving function. Operation 510 may include operation contents according to operation 320 of FIG. 3.

According to an embodiment, in operation 520, the electronic device may determine whether the running application includes time information related to the execution of the task. For example, if the running application is a map or navigation application, it may include information regarding the time it takes for the user of the electronic device to reach the destination from the current location.

In an embodiment, when determining that the running application includes the time information related to the execution of the task, operation 540 may be performed.

In an embodiment, when determining that the running application does not include the time information related to the execution of the task, operation 530 may be performed. Even when determining that no application is being executed, the electronic device may perform operation 530.

According to an embodiment, in operation 530, the electronic device may identify the average usage time information of the application based on the information regarding the usage history of the electronic device. When the application is executed, the information regarding the usage history of the application may include information regarding the time taken until the application is terminated.

According to an embodiment, in operation 540, the electronic device may identify the second time. Operation 540 may include operation contents according to operation 340.

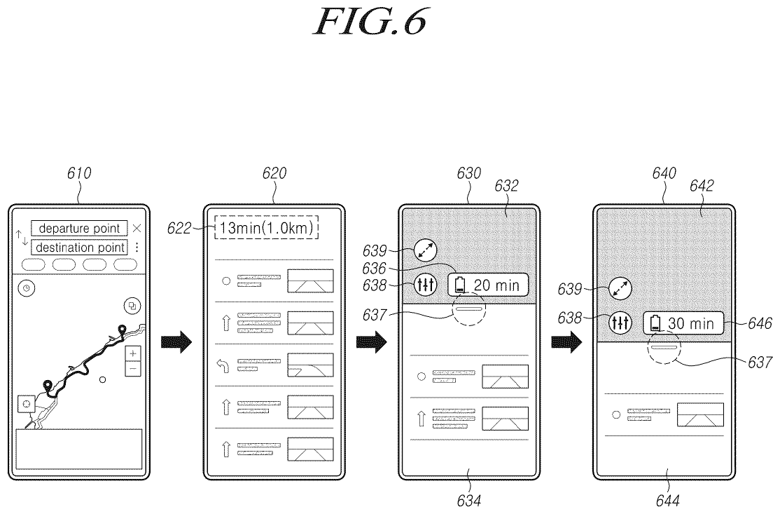

FIG. 6 illustrates an example of displaying a user interface of an electronic device according to an embodiment of the disclosure.

The electronic device of FIG. 6 may include a device corresponding to the electronic device of FIGS. 1 to 5. Among the contents described with reference to FIG. 6, the description of contents overlapping the contents described with reference to FIGS. 1 to 5 may be omitted. The screens illustrated in FIG. 6 may include examples of screens displayed on the display of the electronic device according to the operation of the electronic device of FIG. 3.

In an embodiment, the first user interface 610 may include the user interface displayed on the electronic device when executing a map, route guidance, or navigation application. The user of the electronic device may input a departure point and a destination point in the first user interface 610.

In an embodiment, the second user interface 620 may include the user interface related to the route guidance displayed according to the departure point and the destination point input from the first user interface 610. The second user interface 620 may include an object 622 including information regarding the time and distance remaining to reach the destination.

In an embodiment, the electronic device may identify that the remaining battery level of the electronic device at the time of displaying the second user interface 620 is less than or equal to a threshold and determine that the condition for performing the power saving function is met.

According to an embodiment, the electronic device may identify the estimated available time (first time) of the electronic device. Although not illustrated in the drawings, the first time identified by the electronic device may be identified as 10 minutes.

According to an embodiment, the electronic device may identify a time (second time) required to perform the task of the electronic device. In order to identify the time required for the user to perform the task, it is possible to identify whether there is time information related to performing the task in the app, and accordingly, 13 minutes displayed on the second user interface 620 may be identified.

In an embodiment, the electronic device may determine that the identified second time (13 minutes) is larger than the first time (10 minutes) and may perform at least one power saving function. The electronic device may deactivate some display areas. In other words, the electronic device may reduce the size of the screen output area. The electronic device may lower the brightness of the screen output area.

In an embodiment, the electronic device may display a third user interface 630 in response to performing the power saving function. The third user interface 630 may include a screen output area 634 and an inactive area 632. The available time of the electronic device may be increased by reducing the size of the screen output area 634 to reduce power consumption.

In an embodiment, the third user interface 630 may include a second object 636 indicating the available time of the electronic device. For example, as the electronic device executes the power saving function, the available time may be increased from 10 minutes to 20 minutes, and the increased available time, 20 minutes, may be displayed.

In an embodiment, the third user interface 630 may include an object 637 for adjusting the size of the screen output area 634. In response to identifying a user input of dragging the object 637 to the lower end or upper end of the screen, the sizes of the screen output area 634 and the inactive area 632 may vary.

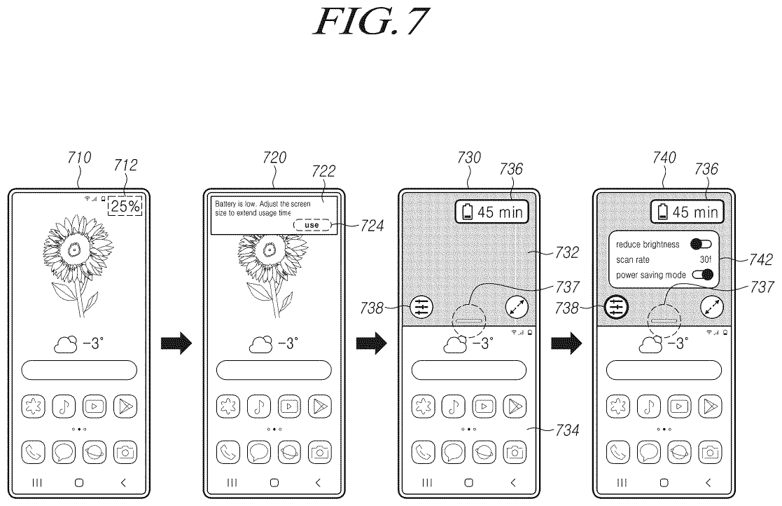

In an embodiment, the third user interface 630 may include an object 638 for displaying at least one power saving function that the electronic device may support. When identifying a user input through the object 638, at least one power saving option that may be supported by the electronic device may be displayed. This may be described in detail in the description of the object 738 of FIG. 7.

In an embodiment, the third user interface 630 may include an object 639 for increasing the size of the inactive area. When identifying a user input through the object 639, the electronic device may extend the size of the inactive area 632 to the entire display area.

In an embodiment, when identifying a user input for dragging the object 637 to the lower end of the screen, the electronic device may display a fourth user interface 640. Referring to the fourth user interface 640 of FIG. 4, the size of the inactive area 642 may be larger than the size of the inactive area 632 of the third user interface 630, and the size of the screen output area 644 may be smaller than the size of the screen output area 634. As the size of the screen output area becomes smaller, the available time may increase, and the electronic device may display an object 646 displaying information regarding the increased available time through the fourth user interface 640.

Although not illustrated in the drawings, when a user input for dragging the object 637 to the upper end is identified, the size of the screen output area may be larger, and accordingly, the available time may be decreased. The decreased available time may be displayed on a user input.

FIG. 7 illustrates an example of displaying a user interface of an electronic device according to an embodiment of the disclosure.

The electronic device of FIG. 7 may include a device corresponding to the electronic device of FIGS. 1 to 6. Among the contents described with reference to FIG. 7, the description of contents overlapping the contents described with reference to FIGS. 1 to 6 may be omitted. The screens illustrated in FIG. 7 may include examples of screens displayed on the display of the electronic device according to the operation of the electronic device of FIG. 3.

In an embodiment, the electronic device may identify that the remaining battery level of the electronic device is decreased to a predetermined value (e.g., 30 percent) or less based on the power usage state information of the electronic device (e.g., operation 320 and operation 420). For example, referring to the first user interface 710, a general home screen of the electronic device is illustrated, and referring to this, it may be identified that the remaining battery level is smaller than the predetermined value (30 percent), as illustrated by the object 712 indicating the current remaining battery level.

In an embodiment, the electronic device may determine that the electronic device meets at least one condition for performing the power saving function, identify the first time and the second time, and determine that the second time is larger than the first time (e.g., operation 330, operation 340, operation 540). Accordingly, the electronic device may display the second user interface 720. The second user interface 620 may include a pop-up window 722 for identifying a user input regarding whether to perform the power saving function. The pop-up window 722 may include an object 724 for identifying a user input for performing the power saving function.

In an embodiment, when the electronic device identifies a user input through the object 724, the electronic device may perform at least one power saving function (e.g., operation 360).

In an embodiment, the electronic device may perform the power saving function and display the third user interface 730 (e.g., operation 370). The third user interface 730 may include an inactive area 732 and a screen output area 734. The content of the electronic device may be displayed through the screen output area 734.

In an embodiment, the third user interface 730 may include an object 736 that displays information regarding the available time as the power saving function is performed.

In an embodiment, the third user interface 730 may include an object 737 for identifying a user input for adjusting the size or ratio of the screen output area 734 and the inactive area 732.

In an embodiment, the third user interface 730 may include an object 738. The object 738 may include an object corresponding to the object 638. In other words, when a user input is identified through the object 738, power saving functions that may be supported by the electronic device may be displayed.

In an embodiment, when identifying a user input through the object 738, the electronic device may display the fourth user interface 740. When the electronic device identifies a user input through the object 738, the electronic device may display an object 742 (e.g., a UI component in the form of a toggle) for receiving a user input regarding whether to execute other power saving options (e.g., lowering brightness, scanning rate, power saving mode, etc.) supportable by the electronic device. Although not illustrated in the drawings, when a user input is identified through the object 742, the power saving function corresponding to the user input may be performed.

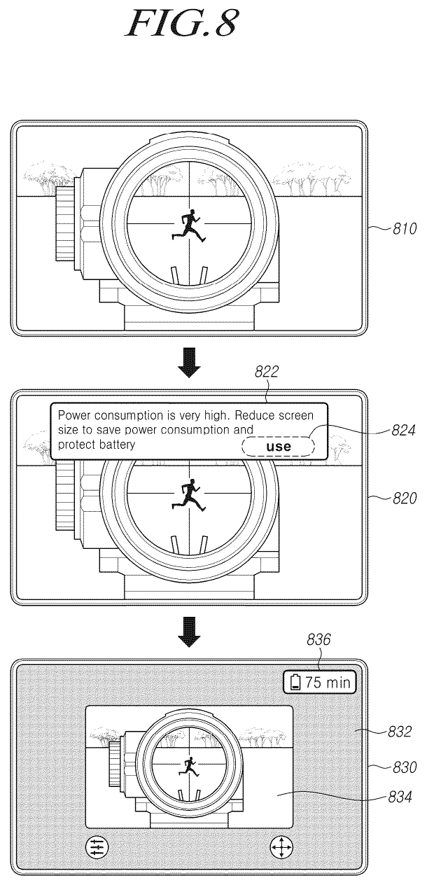

FIG. 8 illustrates an example of displaying a user interface of an electronic device according to an embodiment of the disclosure.

The electronic device of FIG. 8 may include a device corresponding to the electronic device of FIGS. 1 to 7. Among the contents described with reference to FIG. 8, the description of contents overlapping the contents described with reference to FIGS. 1 to 7 may be omitted. The screens illustrated in FIG. 8 may include examples of screens displayed on the display of the electronic device according to the operation of the electronic device of FIG. 3.

Referring to FIG. 8, when an application (e.g., a game) that consumes a lot of power is executed, an example of screen display according to the operation flow of the electronic device is illustrated.

In an embodiment, the first user interface 810 may include a screen displayed as the electronic device executes a game application.

In an embodiment, the electronic device may identify the first time according to the operations according to operations 420, 430, 440, and 450. In an embodiment, when executing a game application and identifying that the power consumption rate is more than or equal to a predetermined value, the electronic device may determine that at least one condition for performing the power saving function is met. In an embodiment, when the game application is executed, the electronic device may determine that at least one condition for executing the power saving function is met. Accordingly, the electronic device may identify the estimated available time (first time) of the electronic device and the time (second time) required to perform the task. Although not illustrated in the drawings, when there is time information necessary for performing the task in the game application (e.g., the information regarding the time required for the session of the game to terminate), the time information may be identified as the second time. In the absence of time information required for the execution of the task in the game application, the electronic device may compile information regarding the time history taken from game execution to termination based on the information regarding the application usage history to determine the average time taken for the game to terminate after execution as the second time.

In an embodiment, the electronic device may determine that the second time is larger than the first time. Accordingly, the electronic device may display the second user interface 820. The second user interface 820 may display a pop-up window 822 for identifying a user input regarding whether to perform the power saving function. The pop-up window 822 may include an object 824. When identifying a user input through the object 824, the electronic device may execute at least one power saving function (e.g., operation 360).

In an embodiment, the electronic device may display the third user interface 830 in response to executing at least one power saving function. Referring to the third user interface 830, the electronic device may reduce the size of the screen output area 834 by performing the power saving function and display the remaining area as the inactive area 832. The third user interface 830 may include an object 836 representing information regarding the available time according to executing the power saving function.

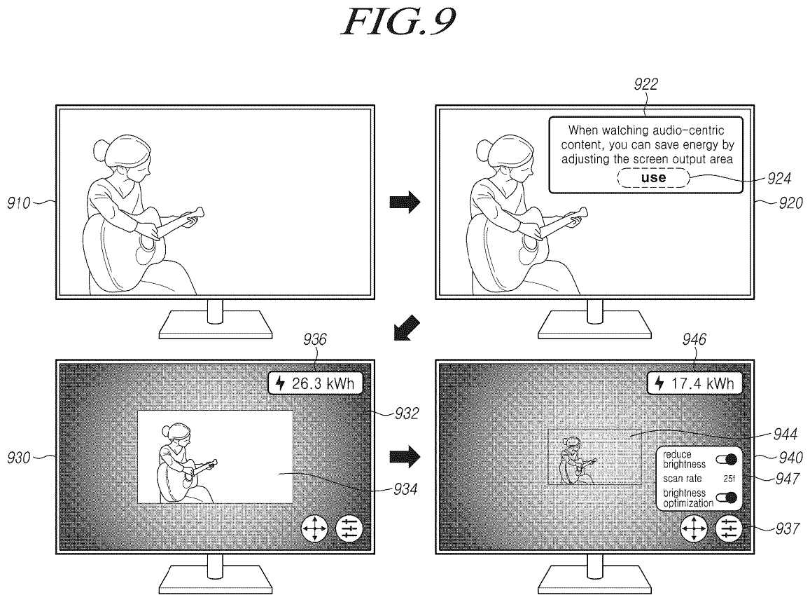

FIG. 9 illustrates an example of displaying a user interface of an electronic device according to an embodiment of the disclosure.

The electronic device of FIG. 9 may include a device corresponding to the electronic device of FIGS. 1 to 8. Among the contents described with reference to FIG. 9, the description of contents overlapping the contents described with reference to FIGS. 1 to 8 may be omitted. The screens illustrated in FIG. 9 may include examples of screens displayed on the display of the electronic device according to the operation of the electronic device of FIG. 3. FIG. 9 illustrates an example of screen display according to an operation flow of the electronic device for reducing power consumption of the electronic device that plays audio-centric content.

In an embodiment, the electronic device may display a first user interface 910 for playing content including audio. When the electronic device determines that the content currently being executed is content including audio, the electronic device may determine that the application running on the electronic device corresponds to the first application in operation 440.

In an embodiment, when the electronic device determines that the application running on the electronic device corresponds to the first application, the electronic device may display the second user interface 920. Regardless of the estimated available time of the electronic device and the time required to perform the task, a pop-up window 922 including an object 924 for identifying a user input regarding whether to execute the power saving function may be displayed.

In an embodiment, when the electronic device identifies a user input through the object 924, the third user interface 930 may be displayed by performing the power saving function (in this case, a function of reducing the screen output area). The third user interface 930 may include a screen output area 934 and an inactive area 932. In the case of audio-centric content, where the content of the visually displayed screen is not important, it may be determined that the user's need for the size of the screen output area is relatively small, and accordingly, the electronic device may reduce the size of the screen output area 934 and display the screen primarily in the inactive area 932.

In an embodiment, the third user interface 930 may include an object 936 representing information regarding power consumption according to performing the power saving function.

In an embodiment, the third user interface 930 may include an object 937. When the electronic device identifies a user input through the object 937, the power saving function option that may be additionally executed may be displayed.

In an embodiment, when identifying a user input through the object 937, the electronic device may display a fourth user interface 940. The fourth user interface 940 may include an object 947 indicating an additionally executable power saving function option (e.g., a toggle component related to brightness adjustment, scan rate adjustment, brightness optimization, or the like). When identifying a user input through the object 947, the electronic device may perform the power saving function corresponding to the identified user input. Referring to the fourth user interface 940 of FIG. 9, it may be identified that the size of the screen output area 944 is further decreased than that of the screen output area 934, and accordingly, the power consumption is decreased through the object 946.

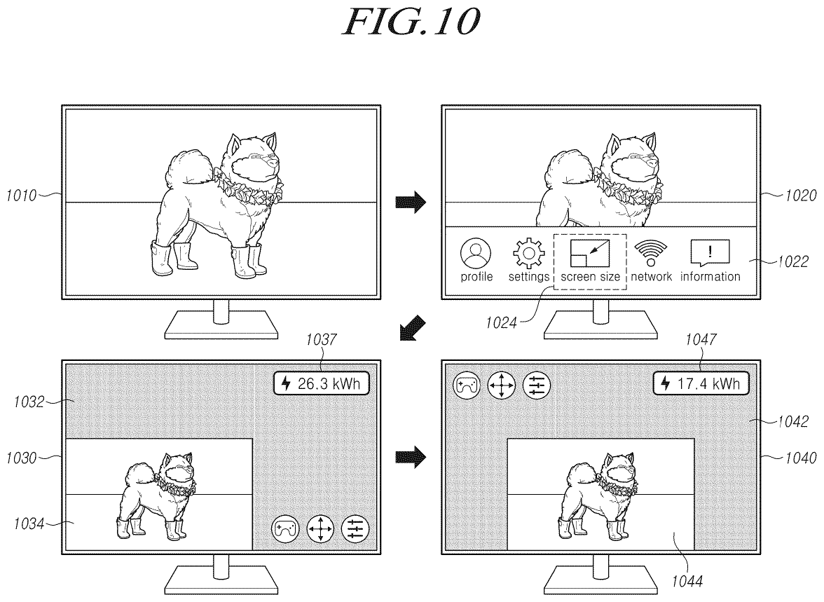

FIG. 10 illustrates an example of displaying a user interface of an electronic device according to an embodiment of the disclosure.

The electronic device of FIG. 10 may include a device corresponding to the electronic device of FIGS. 1 to 9. Among the contents described with reference to FIG. 10, the description of contents overlapping the contents described with reference to FIGS. 1 to 9 may be omitted. The screens illustrated in FIG. 10 may include examples of screens displayed on the display of the electronic device according to the operation of the electronic device of FIG. 3. FIG. 10 illustrates an example of screen display according to an operation flow of the electronic device for reducing power consumption of the electronic device that plays audio-centric content.

In an embodiment, the electronic device may display a first user interface 1010 regarding an execution screen for an application. In the content displayed on the first user interface 1010, when the output area of the screen is to be changed, the electronic device may display the second user interface 1020.

In an embodiment, the second user interface 1020 may include an object 1022 related to the setting of the electronic device. The object 1022 may include an object 1022 for adjusting the screen output area.

In an embodiment, when the electronic device identifies a user input through the object 1024, the electronic device may display a third user interface 1030. The third user interface 1030 may include the screen output area 1034 and the inactive area 1032. The inactive area 1032 may include information 1037 regarding the amount of power currently being consumed.

In an embodiment, when the electronic device identifies a user input through the screen adjustment object of the third user interface 1030, a fourth user interface 1040 may be displayed.

In an embodiment, the fourth user interface 1040 may include the screen output area 1044 disposed at the center of the screen. Accordingly, the layout of the inactive area 1042 may also be changed. Further, the fourth user interface 1040 may include an object 1047 representing information regarding power consumption that changes as the arrangement of the screen output area changes.

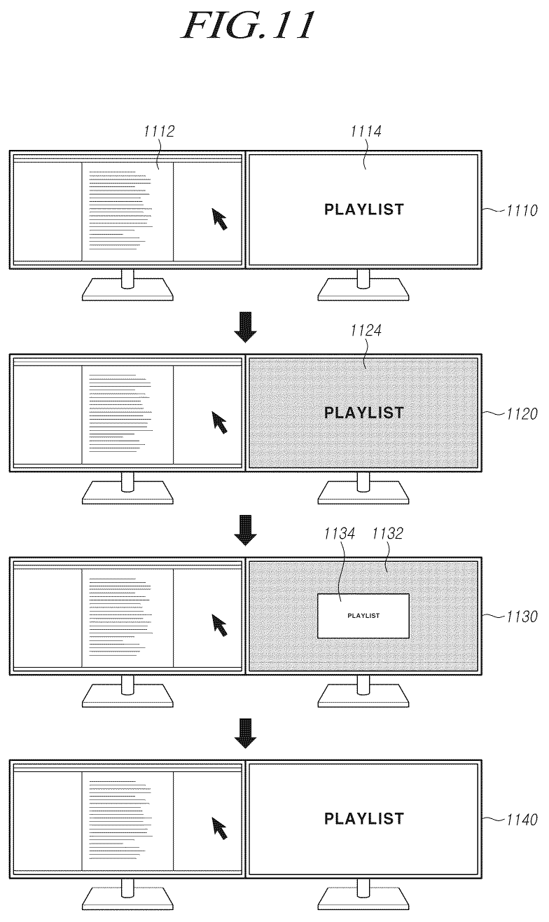

FIG. 11 illustrates an example of screen display of an electronic device according to an embodiment of the disclosure.

The electronic device of FIG. 11 may include a device corresponding to the electronic device of FIGS. 1 to 10. Among the contents described with reference to FIG. 11, the description of contents overlapping the contents described with reference to FIGS. 1 to 10 may be omitted. The screens illustrated in FIG. 11 may include examples of screens displayed on the display of the electronic device according to the operation of the electronic device of FIG. 3. FIG. 11 illustrates an example of displaying a screen through a plurality of display devices.

In an embodiment, the electronic device may display a first screen 1112 and a second screen 1114 in a first step 1110. For example, the first screen 1112 may represent a screen on which the user is working, and the second screen 1114 may represent a screen of an Internet window on which the user is running to listen to music.

In an embodiment, when a time when an icon (e.g., a mouse cursor) indicating an input device (e.g., a mouse) is displayed on the first screen 1112 is a time equal to or more than a predetermined value (e.g., 5 minutes), the electronic device may decrease the brightness of the second screen 1114 in a second step 1120. Accordingly, the second screen 1124 may have lower brightness than the second screen 1114.

In an embodiment, in the third step 1130, when a time when an icon (e.g., a mouse cursor) indicating an input device (e.g., a mouse) is displayed on the first screen 1112 is more than or equal to the predetermined value (e.g., 15 minutes), the electronic device may reduce the size of the screen output area 1134 in a third step 1130. Accordingly, the second screen may include the screen output area 1134 and the inactive area 1132. A screen may be displayed in the screen output area 1134, but a screen may not be displayed in the inactive area 1132.

In an embodiment, in a fourth step 1140, when the icon indicating the input device moves to the second screen, the electronic device may adjust the brightness to be higher again.

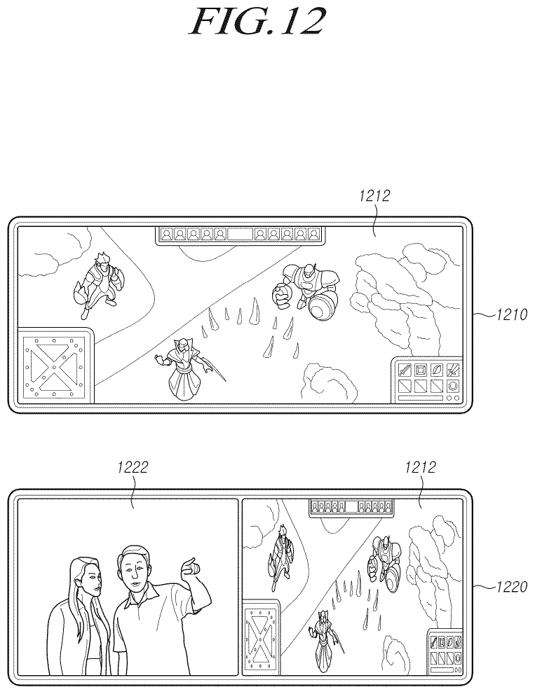

FIG. 12 illustrates an example of displaying a user interface of an electronic device according to an embodiment of the disclosure.

The electronic device of FIG. 12 may include a device corresponding to the electronic device of FIGS. 1 to 11. Among the contents described with reference to FIG. 12, the description of contents overlapping the contents described with reference to FIGS. 1 to 11 may be omitted. The screens illustrated in FIG. 12 may include examples of screens displayed on the display of the electronic device according to the operation of the electronic device of FIG. 3. FIG. 12 illustrates an example of displaying a user interface of the electronic device when a plurality of (two) applications are executed while executing one application.

In an embodiment, the electronic device may display the first user interface 1210. The first user interface 1210 may include the user interface displayed when an application related to a game (hereinafter, referred to as the first application) is executed. The first user interface 1210 may include an execution screen 1212 of the first application.

In an embodiment, the electronic device may identify that another application (e.g., content playback) (hereinafter, a second application) is executed while executing the application related to the game. In this case, the electronic device may display the second user interface 1220. The second user interface 1220 may include an execution screen of the first application and the execution screen of the second application 1222.

In an embodiment, the second user interface 1220 may be displayed with a brightness lower than the displayed brightness of the first user interface 1210. Since there is more power consumed when performing a plurality of tasks than when performing one task, brightness may be decreased.

In an embodiment, the RAM usage regarding executing the first application of the electronic device may be set to be lower when the second user interface 1220 is displayed than when the first user interface 1210 is displayed. Since more power is consumed when performing a plurality of tasks than when performing one task, the electronic device may reduce the memory usage for the first application for smooth execution of the second application.

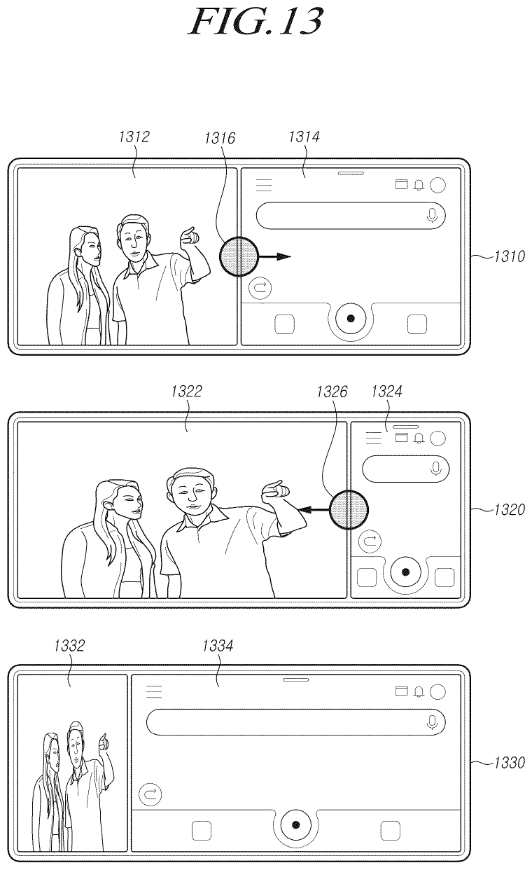

FIG. 13 illustrates an example of execution of a power saving function according to a user input of an electronic device according to an embodiment of the disclosure.

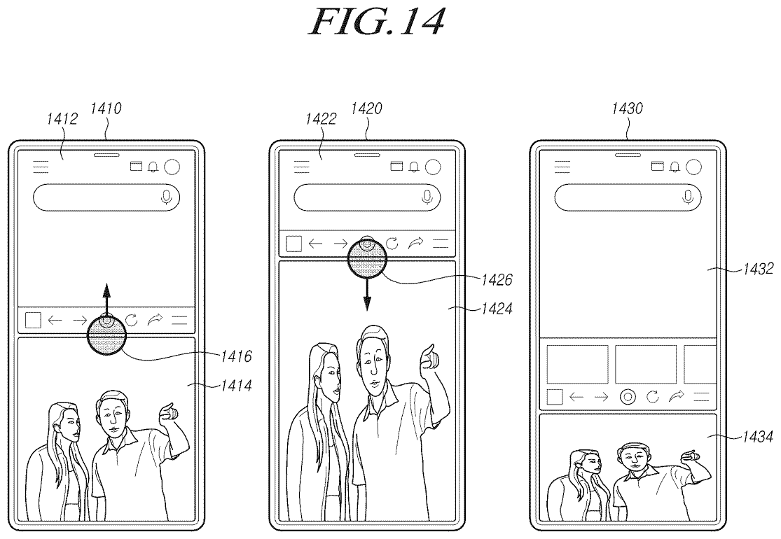

FIG. 14 illustrates an example of execution of a power saving function according to a user input of an electronic device according to an embodiment of the disclosure.

The electronic devices of FIGS. 13 and 14 may include devices corresponding to the electronic devices of FIGS. 1 to 12. Among the contents described with reference to FIGS. 13 and 14, the description of contents overlapping the contents described with reference to FIGS. 1 to 12 may be omitted. The screens illustrated in FIG. 14 may include examples of screens displayed on the display of the electronic device according to the operation of the electronic device of FIG. 3. FIGS. 13 and 14 illustrate an example of a change in screen size and performing the power saving function according to a user input of adjusting the size of one of multiple windows in the electronic device supporting a multi-view function.

According to an embodiment, in the first step 1310, the electronic device may display a first screen 1312 and a second screen 1314. The first screen 1312 and the second screen 1314 may be displayed side by side in the horizontal direction. According to an embodiment, the electronic device may identify a user input 1316 for extending the first screen 1312.

According to an embodiment, in the second step 1320, in response to identifying a user input 1316 for extending the first screen 1312, the electronic device may display an extended first screen 1322 of the first screen 1312 and a second screen 1324 reduced as the first screen is extended.

In an embodiment, the electronic device may increase the brightness of the first screen 1322 as the first screen 1312 is extended to the first screen 1322. In an embodiment, as the first screen 1312 is extended to the first screen 1322, the electronic device may reduce the brightness of the second screen 1324.

In an embodiment, as the first screen 1312 is extended to the first screen 1322, the electronic device may increase the RAM usage of the application displayed on the first screen 1322. In an embodiment, as the first screen 1312 is extended to the first screen 1322, the electronic device may reduce the RAM usage of the second screen 1324.

In an embodiment, the electronic device may identify a user input 1326 for extending the second screen 1324.

According to an embodiment, in the third step 1330, the electronic device may display an extended second screen 1334 of the second screen 1324 and a reduced first screen 1332 of the first screen 1322 in response to identifying a user input 1326 for extending the second screen 1324.

In an embodiment, as the second screen 1324 is extended to the second screen 1334, the electronic device may increase the brightness of the second screen 1334. As the first screen 1322 is decreased to the first screen 1332, the electronic device may reduce the brightness of the first screen 1332.

In an embodiment, as the second screen 1324 is extended to the second screen 1334, the electronic device may increase the RAM usage of the second screen 1334. As the electronic device reduces the first screen 1322 to the first screen 1332, the electronic device may reduce the RAM usage of the first screen 1332.

According to an embodiment, in the first step 1410, the electronic device may display a first screen 1414 and a second screen 1412. The first screen 1414 and the second screen 1412 may be displayed side by side in the vertical direction. According to an embodiment, the electronic device may identify a user input 1416 for extending the first screen 1414.

According to an embodiment, in the second step 1420, in response to identifying a user input 1416 for extending the first screen 1414, the electronic device may display an extended first screen 1424 of the first screen 1414 and a second screen 1422 reduced as the first screen is extended.

In an embodiment, the electronic device may increase the brightness of the first screen 1424 as the first screen 1414 is extended to the first screen 1424. In an embodiment, the electronic device may reduce the brightness of the second screen 1412 as the first screen 1414 is extended to the second screen 1422.

In an embodiment, as the first screen 1414 is extended to the first screen 1424, the electronic device may increase the RAM usage of the application displayed on the first screen 1424. In an embodiment, as the first screen 1414 is extended to the first screen 1424, the electronic device may reduce the RAM usage of the second screen 1422.

In an embodiment, the electronic device may identify a user input 1426 for extending the second screen 1422.

According to an embodiment, in the third step 1430, the electronic device may display an extended second screen 1432 of the second screen 1422 and a reduced first screen 1434 of the first screen 1424 in response to identifying a user input 1426 for extending the second screen 1422.

In an embodiment, as the second screen 1422 is extended to the second screen 1432, the electronic device may increase the brightness of the second screen 1432. As the first screen 1424 is decreased to the first screen 1434, the electronic device may reduce the brightness of the first screen 1434.

In an embodiment, as the second screen 1422 is extended to the second screen 1432, the electronic device may increase the RAM usage of the second screen 1432. As the electronic device reduces the first screen 1424 to the first screen 1434, the electronic device may reduce the RAM usage of the first screen 1434.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic device, the method comprising:
obtaining, by the electronic device, information regarding a power usage state of the electronic device;
determining, by the electronic device, based on the information regarding the power usage state, whether the electronic device satisfies at least one condition for executing a power saving mode;
identifying, by the electronic device, a first time indicating an estimated available time of the electronic device in response to determining that the electronic device satisfies the at least one condition for executing the power saving mode;
identifying, by the electronic device, a second time indicating a time required for a user of the electronic device to perform a task;
determining, by the electronic device, whether the second time is greater than the first time;
performing, by the electronic device, at least one power saving function for reducing power consumption in response to determining that the second time is greater than the first time; and
displaying, by the electronic device, a user interface regarding a power saving function providable by the electronic device,
wherein the user interface includes one or more second objects for executing one or more power saving options providable by the electronic device.

2. The method of claim 1, further comprising:
displaying a first object indicating an object for identifying a user input regarding whether to perform the at least one power saving function for reducing power consumption in response to determining that the second time is greater than the first time; and
performing the at least one power saving function in response to identifying a user input through the first object.

3. The method of claim 2, wherein the user interface includes an object indicating information regarding an estimated available time of the electronic device changed as the at least one power saving function is performed.

4. The method of claim 2, further comprising:
identifying a user input for selecting at least one of the one or more second objects; and
performing a power saving function corresponding to the at least one second object in response to identifying the user input for selecting the at least one second object.

5. The method of claim 4, wherein the user interface includes an object indicating information regarding an estimated usage time of the electronic device changed as the power saving function corresponding to the at least one second object is performed.

6. The method of claim 1, wherein at least one condition for the electronic device to execute the power saving mode includes at least one of a first condition indicating that the electronic device identifies that a battery status of the electronic device is less than a first threshold, a second condition indicating that the electronic device identifies that a power consumption rate of the electronic device is a second threshold or more, or a third condition including a case where it is identified that the electronic device executes at least one predetermined application among a plurality of applications installed on the electronic device.

7. The method of claim 1, wherein the at least one power saving function includes a function of reducing a size of a screen output area and a function of reducing a screen brightness.

8. The method of claim 7, further comprising:
displaying the screen output area reduced as the function of reducing the size of the screen output area is performed;
identifying a user input for adjusting the reduced size of the screen output area;
identifying an estimated available time of the electronic device changed, in response to the user input for adjusting the reduced size of the screen output area; and
displaying information regarding the changed estimated available time of the electronic device.

9. The method of claim 2, further comprising:
displaying a first screen indicating an execution screen of a first application and a second screen indicating an execution screen of a second application;
identifying a user input for expanding the first screen and reducing the second screen; and
increasing a brightness of the first screen and decreasing a brightness of the second screen.

10. The method of claim 9, further comprising:
increasing a system resource allocated to the first application and reducing a system resource allocated to the second application.

11. An electronic device, comprising:
a display;
memory, comprising one or more storage media, storing instructions; and
at least one processor, communicatively coupled to the display and the memory, including a processing circuit,
wherein the instructions, when executed by the at least one processor individually or collectively, cause the electronic device to:
obtain information regarding a power usage state of the electronic device,
determine, based on the information regarding the power usage state, whether the electronic device satisfies at least one condition for executing a power saving mode,
identify a first time indicating an estimated available time of the electronic device in response to determining that the electronic device satisfies the at least one condition for executing the power saving mode,
identify a second time indicating a time required for a user of the electronic device to perform a task,
determine whether the second time is greater than the first time,
perform at least one power saving function for reducing power consumption in response to determining that the second time is greater than the first time, and
display a user interface regarding a power saving function providable by the electronic device, and
wherein the user interface includes one or more second objects for executing one or more power saving options providable by the electronic device.

12. The electronic device of claim 11, wherein the instructions, when executed by the at least one processor individually or collectively, further cause the electronic device to:
display a first object indicating an object for identifying a user input regarding whether to perform the at least one power saving function for reducing power consumption in response to determining that the second time is greater than the first time, and
perform the at least one power saving function in response to identifying a user input through the first object.

13. The electronic device of claim 12, wherein the user interface includes an object indicating information regarding an estimated available time of the electronic device changed as the at least one power saving function is performed.

14. The electronic device of claim 12, wherein the instructions, when executed by the at least one processor individually or collectively, further cause the electronic device to:
identify a user input for selecting at least one of the one or more second objects, and
perform a power saving function corresponding to the at least one second object in response to identifying the user input for selecting the at least one second object.

15. The electronic device of claim 14, wherein the user interface includes an object indicating information regarding an estimated usage time of the electronic device changed as the power saving function corresponding to the at least one second object is performed.

16. The electronic device of claim 12,
wherein the at least one power saving function includes a function of reducing a size of a screen output area and a function of reducing a screen brightness.

17. The electronic device of claim 16, wherein the instructions, when executed by the at least one processor individually or collectively, further cause the electronic device to:
display the screen output area reduced as the function of reducing the size of the screen output area is performed;
identify a user input for adjusting the reduced size of the screen output area;
identify an estimated available time of the electronic device changed, in response to the user input for adjusting the reduced size of the screen output area; and
display information regarding the changed estimated available time of the electronic device.

18. The electronic device of claim 11, wherein at least one condition for the electronic device to execute the power saving mode includes at least one of a first condition indicating that the electronic device identifies that a battery status of the electronic device is less than a first threshold, a second condition indicating that the electronic device identifies that a power consumption rate of the electronic device is a second threshold or more, or a third condition including a case where it is identified that the electronic device executes at least one predetermined application among a plurality of applications installed on the electronic device.

19. One or more non-transitory computer-readable storage media storing one or more computer programs including computer-executable instructions that, when executed by at least one processor of an electronic device individually or collectively, cause the electronic device to perform operations, the operations comprising:
obtaining, by the electronic device, information regarding a power usage state of the electronic device;
determining, by the electronic device, based on the information regarding the power usage state, whether the electronic device satisfies at least one condition for executing a power saving mode;
identifying, by the electronic device, a first time indicating an estimated available time of the electronic device in response to determining that the electronic device satisfies the at least one condition for executing the power saving mode;
identifying, by the electronic device, a second time indicating a time required for a user of the electronic device to perform a task;
determining, by the electronic device, whether the second time is greater than the first time;
performing, by the electronic device, at least one power saving function for reducing power consumption in response to determining that the second time is greater than the first time; and
displaying, by the electronic device, a user interface regarding a power saving function providable by the electronic device,
wherein the user interface includes one or more second objects for executing one or more power saving options providable by the electronic device.

20. The one or more non-transitory computer-readable storage media of claim 19, the operations further comprising:
displaying a first object indicating an object for identifying a user input regarding whether to perform the at least one power saving function for reducing power consumption in response to determining that the second time is greater than the first time; and
performing the at least one power saving function in response to identifying a user input through the first object.
